(19) United States
(12) Patent Application Publication
(10) Pub. No.: US 2021/0288805 A1
(43) Pub. Date: Sep. 16, 2021

(54) AUTHENTICATION DEVICES AND METHODS FOR INDUSTRIAL CONTROL DEVICES

(71) Applicant: NEC Corporation Of America, Herzlia (IL)

(72) Inventors: Tsvi Lev, Tel-Aviv (IL); Yaacov Hoch, Ramat-Gan (IL)

(73) Assignee: NEC Corporation Of America, Herzlia (IL)

(21) Appl. No.: 16/819,101

(22) Filed: Mar. 15, 2020

(51) Int. Cl. H04L 9/32; G07C 9/21

(52) U.S. Cl. CPC H04L 9/3228; G07C 9/21; H04L 9/3263

(57) ABSTRACT

A method for authenticating communication between an industrial control device and an external control system, comprising: storing, by a key storing module, an authentication key coupled to a matching key of an external control system; calculating, by a processor, an authenticity indication of communication between an industrial control device and the external control system using the authentication key; providing, by a connection module, the authenticity indication to the industrial control device via an input and output (I/O) port of the industrial control device, the connection module is physically and electronically connected to the I/O port.

### FIELD AND BACKGROUND OF THE INVENTION

The present invention, in some embodiments thereof, relates to communication authentication for industrial control devices and, more particularly, but not exclusively, to a key-based authentication device using input and output (I/O) port of an industrial control device.

A one-time password (OTP) is a password that is valid for only one login session or transaction, on a computer system or other digital device. Existing OTP tokens rely on physical display, and a person/machine to read this display and the one-time password being displayed on it. Some tokens are integrated into equipment such as computer platforms, so may be used by the equipment's software.

Public key cryptography uses public keys which may be disseminated widely, and private keys which are known only to the owner, to authenticate a holder of the private key the by the paired public key. Secure protocols for public key based authentication are used to authenticate entities to each other via digital messages.

### SUMMARY OF THE INVENTION

According to an aspect of some embodiments of the present invention there is provided a method for authenticating communication between an industrial control device and an external control system, comprising: storing, by a key storing module, an authentication key coupled to a matching key of an external control system; calculating, by a processor, an authenticity indication of communication between an industrial control device and the external control system using the authentication key; providing, by a connection module, the authenticity indication to the industrial control device via an input and output (I/O) port of the industrial control device.

Optionally, the connection module is physically and electronically connected to the I/O port.

Optionally, the authentication indication is a one-time password (OTP).

More optionally, the calculating includes continuously creating the OTP.

Optionally, the authentication key is a private key that is coupled to a matching public key that is stored in a memory of the external control system.

Optionally, the authentication key is a public key that is coupled to a matching private key that is stored in a memory of the external control system.

Optionally, for authenticating an industrial control device to an external control system, the method further comprises, before the calculating: receiving a request signal comprising a request message received by the industrial control device from the external control system; wherein the authenticity indication is forwarded by the industrial control device to the external control system to confirm that the industrial control device has access to the authentication device.

More optionally, wherein the request signal is received from the industrial control device via the I/O port.

More optionally, the request signal is received directly from the external control system.

More optionally, the request message includes a random sequence and the calculating includes signing the random sequence using a private key.

More optionally, the request message includes a sequence encrypted using a public key, and the calculating includes decrypting the sequence using a matching private key.

Optionally, for authenticating an external control system to an industrial control device, the method further comprises, before the calculating: receiving a request signal comprising a passkey received from the external control system; wherein the calculating includes verifying authenticity of the passkey.

More optionally, the method further comprises: when the authenticity is not verified, sending instruction to stop at least one action of the industrial control device.

More optionally, the passkey is a one-time password (OTP) generated by external control system and the calculating includes generating a matching OTP.

More optionally, the passkey is generated by the external control system using a private key and the calculating is done using a matching public key.

Optionally, the connection module is transmitting electromagnetic signals that are received by the input and output (I/O) port, and receives electromagnetic signals transmitted by the input and output (I/O) port.

More optionally, at least one of the connection module and the input and output (I/O) port is transmitting electromagnetic signals via an electromagnetic transmitter.

More optionally, the at least one of the connection module and the input and output (I/O) port receiving electromagnetic signals via an electromagnetic receiver.

According to an aspect of some embodiments of the present invention there is provided an authentication device for authenticating communication between an industrial control device and an external control system, comprising: a key storing module, storing an authentication key coupled to a matching key of an external control system; a connection module, physically and electronically connected to an input and output (I/O) port of an industrial control device; and a processor which provides an authenticity indication of communication between the industrial control device and the external control system via the connection module to the industrial control device using the authentication key.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of authenticating communication between an industrial control device and an external control system, according to some embodiments of the present invention;

FIG. 2 is a flowchart schematically representing a method for authenticating communication between an industrial control device and an external control system, according to some embodiments of the present invention;

FIG. 3 is flowchart schematically representing an exemplary method for authenticating an industrial control device to an external control system, according to some embodiments of the present invention;

FIG. 4 is exemplary ladder logic for authenticating an industrial control device to an external control system, according to some embodiments of the present invention;

FIG. 5 is a flowchart schematically representing an exemplary method for authenticating an external control system to an industrial control device, according to some embodiments of the present invention; and

FIG. 6 is exemplary ladder logic for authenticating an external control system to an industrial control device, according to some embodiments of the present invention.

### DETAILED DESCRIPTION

The present invention, in some embodiments thereof, relates to communication authentication for industrial control devices and, more particularly, but not exclusively, to a key-based authentication device using input and output (I/O) port of an industrial control device.

It may be beneficial for industrial control devices to authenticate their identity to external systems or verify authenticity of these external systems and messages received from them. This may be useful, for example, for protecting the industrial control device from unauthorized and/or malicious control software trying to pose as the ‘legitimate’ control center.

Most industrial control devices, such as programmable logic controllers (PLCs) and remote terminal units (RTUs), do not include built in authentication mechanism. Also, these industrial control devices may not be easily and/or safely modified to include an authentication element such as a one-time password (OTP) token, which may also be forbidden by the vendor and/or void warranty.

According to some embodiments of the present invention, there is provided an authentication device which includes a key storing module, a connection module and a processor. The key storing module (such as a memory) holds an authentication key, which is coupled to a matching key of an external control system. The connection module is connected to an input and output (I/O) port of an industrial control device. The processor uses the authentication key to calculate an authenticity indication of the communication between the industrial control device and the external control system. It then provides this indication to the industrial control device via the connection module and the I/O port of an industrial control device.

I/O ports are normally used to connect the industrial control device to sensors and actuators by discrete or analog signals. Since the authentication device is connected to the industrial control device via this type of port, it may be separated from the network that is used for communication between the industrial control device and the external control system. This configuration makes it harder for an attacker trying to provide false authentication, to hack, simulate and/or bypass the authentication device.

The authentication device may be added on to any industrial control device in a non-intrusive way which does not require deep involvement of the vendor. Integration of the authentication device may not require any change in the industrial control device, or may require changes only in the programmable logic (ladder logic).

According to some embodiments, the identity and/or messages of the industrial control device is authenticated to the external control system by an authentication device. The authentication device receives a request message originated from the external control system and calculates an authenticity indication using the authentication key, matching with the external control system. The authenticity indication may be for example an OTP or may be based on public key cryptography. The authentication device then sends the authenticity indication to the industrial control device via an I/O port connecting them. The industrial control device forwards the authentication passkey to the external control system which verifies the authenticity of the authentication passkey. The authenticity of the authenticity indication received from the industrial control device indicates to the external control system that the industrial control device has access to the authentication device.

According to some embodiments, the identity and/or messages of the external control system is authenticated to the industrial control device by an authentication device. The authentication device receives a passkey originated from the external control system and verifies the authenticity of the passkey. The authentication device then sends an authenticity indication to the industrial control device via the I/O, and may also automatically instruct security measures when authenticity is not verified.

According to some embodiments, the connection module is not physically connected to the I/O port of the industrial control device, but is receiving electromagnetic signals that are transmitted from the I/O port, and transmits electromagnetic signals to be received by the I/O port. This may be done, for example, by a transmitter and receiver devices.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

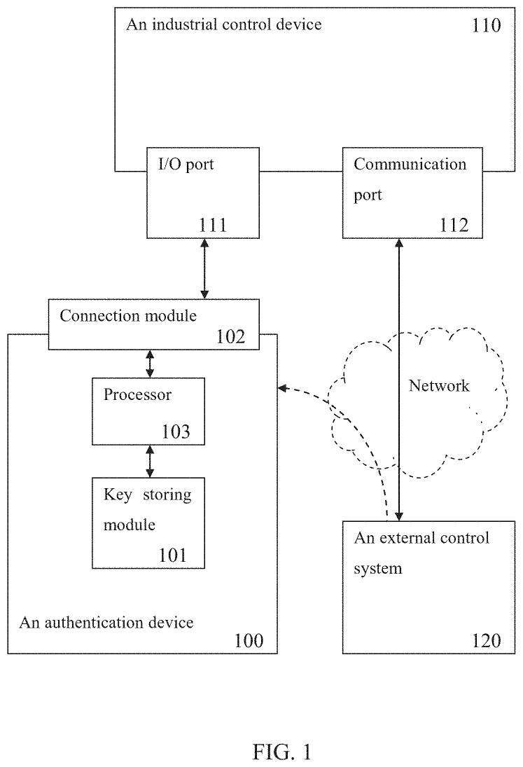

Referring now to the drawings, FIG. 1 is a schematic illustration of a system of authenticating communication between an industrial control device and an external control system, according to some embodiments of the present invention.

An authentication device 100 provides authenticity indication to industrial control device 110. Authentication device 100 may be any kind of computing device, and includes a key storing module 101, a connection module 102 and a processor 103. Key storing module 101 may be, for example, any kind of memory such as a non-transitory computer readable storage medium. Connection module 102 may be physically and electronically connected to an input and output (I/O) port 111 of industrial control device 110. Connection module 102 may include a matching I/O port, which is connected to I/O port 111, for example via a cable. Optionally, connection module 102 is connected to multiple I/O ports, serially and/or in parallel, so larger amount of data may be transferred. Processor 103 may include, for example, one or more central processing units (CPUs), graphics processing units (GPUs) and/or any kind of processing component or combination thereof.

Industrial control device 110 may include any type of control device, system and/or associated instrumentation used for industrial process control. This may include, for example, programmable logic controllers (PLCs), supervisory control and data acquisition (SCADA) systems, individual remote terminal units (RTUs), distributed control systems (DCS), and/or combination thereof.

I/O port 111 may be a discrete port or an analog port. These ports read and write discrete or analog electrical signals, and are otherwise used to connect industrial control device 110 to sensors and actuators. Discrete signals behave as binary switches with only two states, yielding an On or Off signal (1 or 0, True or False, respectively), and are sent using either voltage or current, where a specific range is designated as On and another as Off. Analog signals have a range of values between zero and full-scale, and may be interpreted as integer values (counts) by industrial control device 110, with various ranges of accuracy. An analog I/O port may use voltage or current with a magnitude proportional to the value of the signal. I/O port 111 may read and/or write multiple discrete levels by using digital-to-analog and/or analog-to-digital converter.

An external control system 120 communicates with industrial control device 110 via a communication port 112 of industrial control device 110, for example by a cable. Communication port 112 may be, for example, USB, Ethernet, RS-232, RS-485, RS-422 or any other port included in industrial control device 110 and may be managed by the underlying firmware or operating system of industrial control device 110. External control system 120 may also communicate with industrial control device 110 via a network, for example may include, for example, local area network (LAN), a wireless network such as mobile network, wireless local area network (WLAN) such as Wireless Fidelity (WiFi™), a wireless personal area network (WPAN) such as Bluetooth™ protocol, near-field communication (NFC) and/or any other network.

External control system 120 may include any kind of computing device which communicated with industrial control device 110. This may include any other industrial control device as described above. This may also include may include one or more computing devices such as a mainframe computer, an enterprise server, a workstation, multiple connected computers, one or more virtual machines and/or a personal computer.

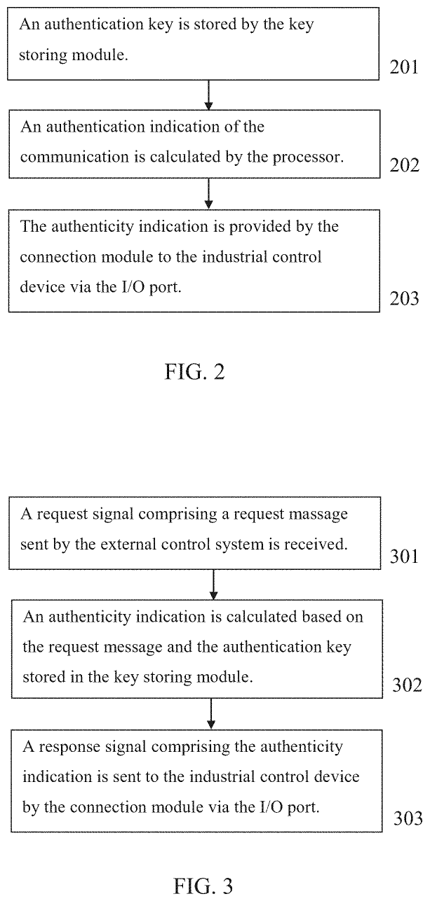

Reference is also made to FIG. 2, which is a flowchart schematically representing a method for authenticating communication between an industrial control device and an external control system, according to some embodiments of the present invention.

First, as shown at 201, an authentication key coupled to a matching key of external control system 120 is stored by a key storing module 101.

Optionally, the authentication key is an OTP algorithm that is used by processor 103 to create an OTP. The OTP algorithm may include, for example, time-synchronization OTP, Hash chain algorithm or challenge-response OTP. The OTP algorithm is matching a similar OTP algorithm stored in external control system 120 that is able to produce a similar OTP.

Optionally, the authentication key is a private key or a public key that have a matching public key or private key stored in external control system 120, respectively. The keys are created by a key generation algorithm that outputs the private key and a corresponding public key.

Optionally, the authentication key is a message authentication code (MAC) algorithm that has a matching similar MAC algorithm stored in external control system 120.

Then, as shown at 202, an authenticity indication of the communication between industrial control device 110 and external control system 120 is calculated by processor 103 using the authentication key. The authenticity indication may include an OTP which is calculated continuously or by demand, encrypted or decrypted sequences, a MAC, or a result of authenticity verification, as is exemplified below.

Then, as shown at 203, the authenticity indication is provided by connection module 102 to industrial control device 110 via I/O port 111. When I/O port 111 is a discrete port, the message may be sent as binary sequence over time, for example, by sending one bit (1 or 0) every 5 milliseconds (or for example scan time of the PLC). For example, a sequence of +5V,0V,+5V over 15 milliseconds encodes the sequence ‘101’. When I/O port 111 is an analog port, the message may be sent by using any kind of communication methods, for example, by encoding several bits in a single reading of the analog port. For example, when I/O port 111 is an analog port that may reliably display 256 different values, and the analog-to-digital may reliably read them, 8 bits may be encoded in each port value.

The authenticity indication may then be used by industrial control device 110 to conclude the authenticity of external control system 120 and/or messages received from external control system 120. The authenticity indication may otherwise be forwarded by industrial control device 110 to external control system 120 to be used by external control system 120 to conclude the authenticity of industrial control device 110 and/or messages received from industrial control device 110.

Reference is now made to FIG. 3, which is flowchart schematically representing an exemplary method for authenticating an industrial control device to an external control system, according to some embodiments of the present invention.

First, as shown at 301, a request signal comprising a request message is received by authentication device 100. The request message is sent by external control system 120. The request message may include a request to provide an OTP, may include a random sequence to be signed by a private key, may include an encrypted sequence to be decrypted by a private key, and/or any other authentication request.

Optionally, the request signal is received by authentication device 100 from industrial control device 110 via I/O port 111. When I/O port 111 is a discrete port, the message may be sent as binary sequence over time, as described above.

Optionally, the request message is sent by external control system 120 to industrial control device 110 via a signal which also includes instructions for industrial control device 110 to send the request message to authentication device 100. The instructions are executed by industrial control device 110, and no programming of the programmable logic is required. For example, when using the common ICS protocol Modbus, this may be executed by the Modbus command ‘Write Single’, which is normally used for example to change the value of a given ‘coil’ (output port).

Optionally, the programmable logic is programmed with instructions for sending the request message to authentication device 100 when the request message is received from external control system 120.

The programmable logic may be programmed using standards-based programming languages such as function block diagram (FBD), ladder diagram (LD, or ladder logic), structured text (ST), instruction list (IL) and/or sequential function chart (SFC). This may be done, for example in a special application on a personal computer, then downloaded by a direct-connection cable or over a network to industrial control device 110.

Optionally, the request signal is received directly from external control system 120 via a communication port 102 of authentication device 100. Communication port 102 may be any kind of port as described for communication port 112, and optionally the same kind of port as communication port 112. In this configuration, authentication device 100 is connected to the network of communication between industrial control device 110 and external control system 120 and not separated. This provides less security for authentication device 100, but may require fewer changes (or no changes) in the programmable logic of industrial control device 110.

Then, as shown at 302, an authenticity indication is calculated based on the request message and an authentication key stored in key storing module 101. This may be an algorithm executed by processor 103.

Optionally, the authenticity indication is an OTP, and is generated by an OTP algorithm. The OTP algorithm may include, for example, time-synchronization OTP, Hash chain algorithm or challenge-response OTP.

Optionally, the authenticity indication is generated by a private key that is stored in a memory of authentication device 100.

Optionally, when the request message includes a random sequence to be signed by the private key, a signing algorithm uses random sequence and the private key to produces a signature, which is the authenticity indication.

Optionally, when the request message includes a sequence encrypted by external control system 120 using the public key, a decryption algorithm uses the private key to decrypt the sequence, and the decrypted sequence is the authenticity indication.

Optionally, the authenticity indication is a MAC, and is generated by a MAC algorithm. The MAC algorithm uses a text sequence to create the MAC.

Then, as shown at 303, a response signal comprising the authenticity indication is sent to industrial control device 110 by connection module 102, via I/O port 111, to be forwarded to external control system 120.

Optionally, when the authenticity indication is an OTP, external control system 120 generates a matching OTP by a similar OTP algorithm and compares it to the one received from industrial control device 110 to verify the authenticity of the OTP.

Optionally, when the authenticity indication is a signature created by a random sequence and the private key, external control system 120 uses the public key to verify that the signature was made by the correct private key.

Optionally, when the authenticity indication is a decrypted version of the sequence sent from external control system 120, than external control system 120 compares the decrypted sequence to the original sequence before it was encrypted, to verify that it was decrypted by the correct private key.

Optionally, when the authenticity indication is an MAC and the response signal includes the sequence which was used to create the MAC, external control system 120 generates a matching MAC by a similar MAC algorithm and compares it to the one received from industrial control device 110 to verify the authenticity of the sequence and/or of industrial control device 110.

When the authenticity indication is verified by external control system 120, it is confirmed that industrial control device 110 has access to authentication device 100.

In another exemplary method for authenticating an industrial control device to an external control system, a request signal is received by industrial control device 110 from external control system 120. The request signal may include instructions for industrial control device 110 to read from I/O port 111 an OTP that is created continuously by processor 103 and continuously provided by connection module 102 into I/O port 111. The input may be received as binary sequence over time to create the authentication passkey, as described above. The instructions may than be executed by the ladder logic of industrial control device 110. The instructions may be sent with the request signal from external control system 120, or may be programmed into the ladder logic, as described above. A response signal comprising the OTP may then be sent to industrial control device 110 as described in 303.

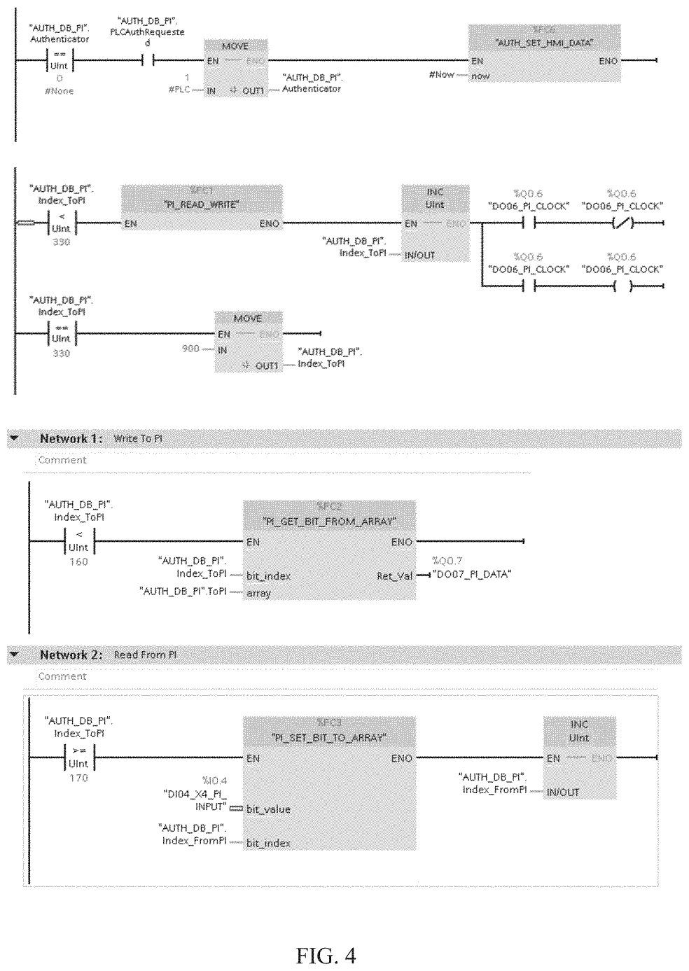

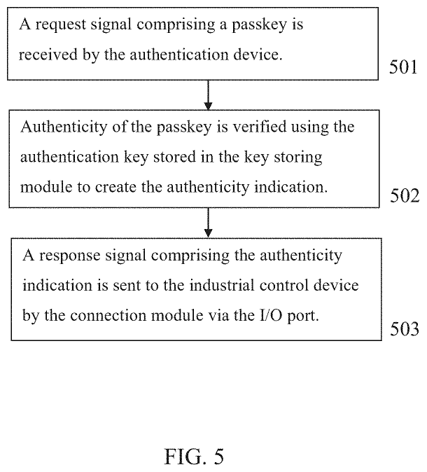

Reference is now made to FIG. 4, which is exemplary ladder logic for authenticating an industrial control device to an external control system, according to some embodiments of the present invention. The ladder logic include instructions for the external control system (HMI) to send authentication data to the industrial control device (PLC) be hashed, instructions for the PLC to calculate a hash and send it to the HMI, and instructions for the HMI to use the hash to validate the PLC. Reference is now made to FIG. 5, which is a flowchart schematically representing an exemplary method for authenticating an external control system to an industrial control device, according to some embodiments of the present invention.

First, as shown at 501, a request signal comprising a passkey is received by authentication device 100. The passkey is sent by external control system 120.

The request signal may be received by authentication device 100 from industrial control device 110 (for example as a binary sequence) or received directly from external control system 120 via communication port 102, as described above for 301.

The request signal may include instructions for industrial control device 110 to send the passkey to authentication device 100, or the ladder logic is programmed with such instructions, as described above for 201.

Optionally, the passkey is an OTP generated by an OTP algorithm of external control system 120.

Optionally, the passkey is generated by a private key that is stored in a memory of external control system 120.

Optionally, the passkey is generated in response to a request message sent to external control system 120 from authentication device 100, directly or via industrial control device 110. For example, when the request message includes a random sequence to be signed by the private key, external control system 120 produces a signature, which is the passkey. For another example, when the request message includes a sequence encrypted by authentication device 100, external control system 120 decrypts the sequence, and the decrypted sequence is the passkey.

Then, as shown at 502, an authenticity indication calculated by processor 103 by verifying the authenticity of the passkey using the authentication key stored in key storing module 101, for example an algorithm correlated with external control system 120. This may be done for OTP, MAC or public key passkeys as is described above for 303 (performed by external control system 120).

Then, as shown at 503, a response signal comprising the authenticity indication is sent from connection module 102 to industrial control device 110 via I/O port 111.

Optionally, when the authenticity is not verified or when an authentication passkey is not received, the response signal includes security instruction to stop one or more actions of industrial control device 110. This may include an alert to industrial control device 110, instructions for the ladder logic to lock, disable or turn off industrial control device 110, instructions for the ladder logic to stop communication via communication port 112 and/or any other security measure. Optionally, authentication device 100 has the ability to instruct the execution of the security instructions by industrial control device 110. Alternatively, ladder logic programming is required to execute the security instructions when received.

In an exemplary embodiment, the control software computer sends the PLC a control command, which includes an OTP message. The ladder logic in the PLC takes this OTP message, breaks it into bits, and ‘sends’ those bits to the authentication device as a series of discrete commands via the port connecting the PLC to the device. The authentication device performs the OTP verification and replies to the ladder logic via a port with a ‘0’ (verification failed) or ‘1’ (verification succeeded). If the reply is ‘0’ the ladder logic takes the proper actions (such as shutting down the PLC, creating an alert, reverting to ‘safe mode’ etc.)

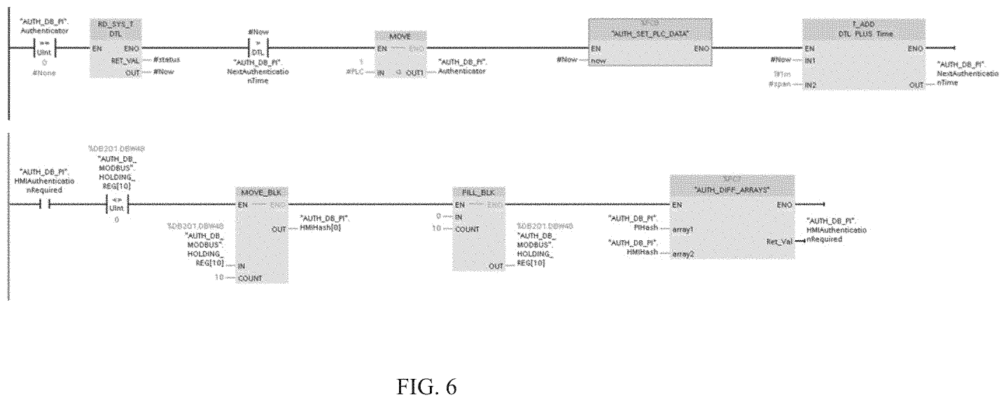

Reference is now made to FIG. 6, which is exemplary ladder logic for authenticating an external control system to an industrial control device, according to some embodiments of the present invention. The ladder logic include instructions for the industrial control device (PLC) to trigger hash calculation by the external control system (HMI), for example every 1 minute, instructions for the HMI calculate a hash and send it to the PLC, and instructions for the PLC to perform hash comparison to validate the HMI.

Following is an exemplary code for validation by hash comparison:
1 #result:=true;
2 FOR #i:=0 TO 9 DO
3 //Statement section FOR
4 #result:=#result AND (#array1 [#i]=#array2[#i]);
5 END FOR;
6 #AUTH_DIFF_ARRAYS:=NOT #result;

Optionally, connection module 102 is not physically connected to I/O port 111, but is receiving electromagnetic signals that are transmitted from I/O port 111, and transmits electromagnetic signals to be received by I/O port 111. This may be done, for example, by connecting a transmitter device and receiver device to connection module 102, and optionally to I/O port 111. Since the signal that is transferred in I/O port 111, it may create electromagnetic pulses that are detected by an electromagnetic sensor with a receiver. Likewise, electromagnetic pulses may be created by a transmitter device and then received by I/O port 111. An exemplary implementation may use a pair of modems to create the non-physical connection.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant industrial control devices will be developed and the scope of the term industrial control device is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for authenticating communication between an industrial control device and an external control system, comprising:
storing, by a key storing module, an authentication key coupled to a matching key of an external control system;
calculating, by a processor, an authenticity indication of communication between an industrial control device and the external control system using the authentication key;
providing, by a connection module, the authenticity indication to the industrial control device via an input and output (I/O) port of the industrial control device.

2. The method of claim 1, wherein the connection module is physically and electronically connected to the I/O port.

3. The method of claim 1, wherein the authentication indication is a one-time password (OTP).

4. The method of claim 3, wherein the calculating includes continuously creating the OTP.

5. The method of claim 1, wherein the authentication key is a private key that is coupled to a matching public key that is stored in a memory of the external control system.

6. The method of claim 1, wherein the authentication key is a public key that is coupled to a matching private key that is stored in a memory of the external control system.

7. The method of claim 1, for authenticating an industrial control device to an external control system, further comprising, before the calculating:
receiving a request signal comprising a request message received by the industrial control device from the external control system;
wherein the authenticity indication is forwarded by the industrial control device to the external control system to confirm that the industrial control device has access to the authentication device.

8. The method of claim 7, wherein the request signal is received from the industrial control device via the I/O port.

9. The method of claim 7, wherein the request signal is received directly from the external control system.

10. The method of claim 7, wherein the request message includes a random sequence and the calculating includes signing the random sequence using a private key.

11. The method of claim 7, wherein the request message includes a sequence encrypted using a public key, and the calculating includes decrypting the sequence using a matching private key.

12. The method of claim 1, for authenticating an external control system to an industrial control device, further comprising, before the calculating:
receiving a request signal comprising a passkey received from the external control system;
wherein the calculating includes verifying authenticity of the passkey.

13. The method of claim 12, further comprising:
when the authenticity is not verified, sending instruction to stop at least one action of the industrial control device.

14. The method of claim 12, wherein the passkey is a one-time password (OTP) generated by external control system and the calculating includes generating a matching OTP.

15. The method of claim 12, wherein the passkey is generated by the external control system using a private key and the calculating is done using a matching public key.

16. The method of claim 1, wherein the connection module is transmitting electromagnetic signals that are received by the input and output (I/O) port, and receives electromagnetic signals transmitted by the input and output (I/O) port.

17. The method of claim 16, wherein at least one of the connection module and the input and output (I/O) port is transmitting electromagnetic signals via an electromagnetic transmitter.

18. The method of claim 16, wherein the at least one of the connection module and the input and output (I/O) port receiving electromagnetic signals via an electromagnetic receiver.

19. An authentication device for authenticating communication between an industrial control device and an external control system, comprising:
a key storing module, storing an authentication key coupled to a matching key of an external control system;
a connection module, physically and electronically connected to an input and output (I/O) port of an industrial control device; and
a processor which provides an authenticity indication of communication between the industrial control device and the external control system via the connection module to the industrial control device using the authentication key.
